(19) United States
(12) Patent Application Publication
(10) Pub. No.: US 2006/0017827 A1
(43) Pub. Date: Jan. 26, 2006

(54) Variable-gain amplifier circuit

(76) Inventors: Kuniyuki Tani, Ogaki-city (JP); Atsushi Wada, Ogaki-city (JP)

Correspondence Address: MCDERMOTT WILL & EMERY LLP, 600 13TH STREET, N.W., WASHINGTON, DC, 20005-3096, US

(21) Appl. No.: 11/186,917

(22) Filed: Jul. 22, 2005

(30) Foreign Application Priority Data
Jul. 23, 2004 (JP) 2004-215366
Jul. 30, 2004 (JP) 2004-222925
Jun. 28, 2005 (JP) 2005-187872

(51) Int. Cl. H04N 5/20

(52) U.S. Cl. 348/255

(57) ABSTRACT

An amplifier circuit is formed by a four-stage variable gain amplifier (VGA) composed of first to fourth VGAs. The variable gain width of each of the four stages of VGAs is 1 to 2. As a whole, the minimum gain is set to 1 whereas the maximum gain is set to 16. The maximum gain of each VGA is small, so that the high-speed operation together with small bias current can be realized.

### BACKGROUND OF THE INVENTION

1. Field of the Invention

The present invention relates to amplifier circuits capable of varying the gain and signal processing circuits for processing the output signals from image pickup devices such as CCD (Charge Coupled Device).

2. Description of the Related Art

As a trend of recent years, more and more of mobile devices, such as mobile phones, are carrying CCD or other image pickup function therein. The number of pixels for such function is often in excess of one million pixels and will further increase in the years ahead. Under these circumstances, there is a demand for faster processing, lower power consumption and higher accuracy of the AFE (analog front end) circuit that processes the output signal from an image pickup device.

The AFE circuit for an image pickup device has a function of amplifying the input signals from the image pickup device with the gain variable in accordance with the amplitude thereof to improve color gradation. That is, when the input signal is small for a certain period of time, the AFE circuit adjusts (i.e., amplifies) the signal amplitude by enlarging the gain, so as to enable the resolution of a subsequent A-D (Analog-to-Digital) converter to work.

FIG. 8 is a circuit diagram showing a structure of a conventional AFE circuit 10 for an image pickup device that has a function as described above (see, for example, Reference (1) in the following Related Art List). This AFE circuit 10 includes a CDS (Correlated Double Sampling) circuit 20 that takes out a voltage corresponding to an image signal from a signal outputted from a CCD 1 with the gain fixed at 1, an amplifier circuit 30 that amplifies the signal outputted from the CDS circuit 20 with a variable gain, and an ADC (Analog-to-Digital Converter) 40 that converts the signal amplified by the amplifier circuit 30 into a digital signal.

The amplifier circuit 30 is formed of a two-stage variable gain amplifier (VGA). That is, the amplifier circuit 30 is constituted by a VGA 32 and a VGA 34. The variable gain of the two-stage VGA is 1 to 8 for VGA 32 and 1 to 2 for VGA 34. The minimum gain of the amplifier circuit 30 as a whole is 1, whereas the maximum gain thereof is set at 16.

FIG. 9 is a circuit diagram of a VGA configured as a switched-capacitor circuit. This VGA is composed of a differential amplifier OP, capacitors C1 to C6, and switches SW1 to SW4. The gain of the VGA is determined by the ratio between the input capacitance and the feedback capacitance of the differential amplifier OP. For example, let us suppose the capacitance of the capacitors C1 to C4 is 2C each and that of the capacitors C5 and C6 is C each. Then, when SW1 and SW4 only are turned on, the input capacitance is 2C and the feedback capacitance is C, and therefore the gain is 2. In a similar manner, when SW1 to SW4 are all turned on, the input capacitance is 4C and the feedback capacitance is C, and therefore the gain is 4.

As described above, a VGA configured as a switched-capacitor circuit can vary the gain by changing the input capacitance value and the feedback capacitance value with switches. A VGA configured as a switched-capacitor circuit is also called a PGA (Programmable Gain Amplifier) because the control signal for operating the switches is a digital signal.

### RELATED ART LIST

(1) Y. Fujimoto et al., “A Switched-Capacitor Variable Gain Amplifier for CCD Image Sensor Interface System”, ESSCIRC 2002, pp. 363-366, 2002.

The maximum operating frequency f of a VGA configured as a switched-capacitor circuit is given by the following Equation (1):
f=Gm/(CL·(G+1)) (1)
where Gm is the mutual conductance of the VGA, CL is the load capacitance of the VGA, and G is the gain of the VGA.

There is the following relationship (Equation (2)) between the mutual conductance Gm and the bias current I of a VGA:
Gm∝(β·I)^{1/2} (2)
where β is a constant to be determined by the manufacturing process of the transistor and the shape thereof.

As Equation (1) indicates, a VGA must be so designed as to have a large mutual conductance Gm if the VGA is to be operated at high speed when a large gain is set therefor. The raising of large mutual conductance Gm, on the other hand, will result in an exponential increase of necessary bias current I as Equation (2) indicates. With the conventional circuit structure of an AFE circuit, it is necessary to supply an extremely large bias current to operate the VGAs at high speed because the maximum gain of some of the VGAs is large. This poses an impediment to reduction of power consumption.

### SUMMARY OF THE INVENTION

The present invention has been made in view of the foregoing circumstances and problems, and an object thereof is to provide an amplifier circuit that offers both high-speed operation and reduced power consumption.

A preferred mode of carrying out the present invention relates to an amplifier circuit. This circuit has a plurality of stages of amplifiers and is characterized in that each of the plurality of stages of amplifiers is configured in a manner such that gain is variably set to at least two kinds in a range between 1 and 2 and gain of the amplifier circuit as a whole is determined by controlling gain of each amplifier.

According to this mode of carrying out the present invention, the gain of each amplifier is small, namely, in the range of 1 to 2, so that the high speed operation of an amplifier can be enhanced with the small bias current. As a result thereof, both reduced power consumption and high-speed operation can be achieved for an amplifier circuit.

Here, “in a range between 1 and 2” means that the gain lies within the range of 1 to 2 in design specifications for ideal performance of an amplifier circuit or the like. However it also includes a case of “in a range practically between 1 and 2” which is a realistic case where the gain is somehow outside the range of 1 to 2 in realistic performance.

The gain of each amplifier according to this mode of carrying out the present invention may be set in such a manner as to be selectable as 1 or 2. Thereby, the gain of an amplifier circuit as a whole can be controlled with ease, so that a control circuit for controlling the gain of each amplifier can be produced at low cost or the area for such a control circuit can be efficiently used and reduced.

The amplifier according this mode of carrying out the present invention may be a variable-gain amplifier configured by a switched-capacitor circuit. The switched-capacitor circuit can easily realize variable resistance by switches and capacitors, so that the variable-gain amplifier can be easily implemented into an integrated circuit.

Another preferred mode of carrying out the present invention relates also to an amplifier circuit. This amplifier circuit has a plurality of stages of amplifiers, in which a maximum value of gain (hereinafter referred to “maximum gain” also) as a whole is given by Gmax, and is characterized in that gain of each of the plurality of amplifiers is variably set to at least two values in a range between 1 and X (X≦2) and the amplifiers are connected in n stages in a cascaded manner where n is a natural number such that Gmax≦Xⁿ.

According to this mode of carrying out the present invention, a plurality of amplifiers, in which the gain of each amplifier is small, namely, in the range of 1 to 2, are connected in n stages in a cascaded manner so as to obtain the maximum gain Gmax, so that the high speed operation of an amplifier can be enhanced in the state where the bias current of each amplifier is being reduced. As a result thereof, both reduced power consumption and high-speed operation can be achieved for an amplifier circuit.

Moreover, X may be 2 and the gain of each amplifier may be variably set by two values which are 1 and 2. Thereby, the gain of an amplifier circuit as a whole can be controlled with ease, so that a control can be produced at low cost.

Still another preferred mode of carrying out the present invention relates to a signal processing circuit. This circuit comprises: a sampling circuit which takes out, from a signal outputted by an image pickup device, a voltage corresponding to an image signal; an amplifier circuit which amplifies the voltage taken out by the sampling circuit; and an analog-to-digital conversion circuit which converts the voltage amplified by the amplifier circuit to a digital signal.

According to this mode of carrying out the present invention, the gain of each amplifier is small, namely, in the range of less than or equal to 2, so that the high speed operation of an amplifier can be enhanced with the small bias current. As a result thereof, both reduced power consumption and high-speed operation can be achieved for a signal processing circuit.

Still another preferred mode of carrying out the present invention relates also to a signal processing circuit. This circuit comprises: an amplifier circuit defined according to any mode of carrying out the present invention; and an analog-to-digital conversion circuit which converts the voltage amplified by the amplifier circuit to a digital signal, wherein an amplifier of first stage in the amplifier circuit samples a voltage corresponding to an image signal, from a signal inputted by an image pickup device.

The sampling circuit and the amplifier are subject to the effect of thermal noise. Thus, if the sampling circuit and a plurality of amplifiers are cascade-connected as in any mode of carrying out the present invention, thermal noise is caused. However, since according to this mode of carrying out the present invention the amplifier of the first stage in the amplifier circuit plays a role of sampling circuit, the number of the sampling circuit and the stages of amplifiers can be reduced, so that the accuracy deterioration caused by thermal noise can be minimized.

Still another preferred mode of carrying out the present invention relates to a digital camera. This camera comprises: an image pickup device; a signal processing circuit, defined according to any mode of carrying out the present invention, which takes out, from a signal inputted by the image pickup device, a voltage corresponding to an image signal, amplifies the voltage and converts the amplified voltage to a digital signal; an image compression circuit which performs image compression processing on the digital signal. According to this mode of carrying out the present invention, the gain of each of amplifiers that constitute an amplifier circuit included in the signal processing circuit is small, namely, in the range of less than or equal to 2, so that the high speed operation of an amplifier can be enhanced with the small bias current. As a result thereof, both reduced power consumption and high-speed operation can be achieved for a digital camera.

It is to be noted that any arbitrary combination or rearrangement of the above-described structural components and so forth are all effective as and encompassed by the present embodiments.

Moreover, the summary of the invention does not necessarily describe all necessary features, so that the invention may also be sub-combination of these described features.

### BRIEF DESCRIPTION OF THE DRAWINGS

Embodiments will now be described, by way of examples only, with reference to the accompanying drawings which are meant to be exemplary, not limiting, and wherein like elements are numbered alike in several Figures, in which:

FIG. 1 illustrates a structure of a digital camera according to a first embodiment of the present invention.

FIG. 2 illustrates an example of VGAs, configured as a switched-capacitor circuit, whose gain can be set in the range between 1× and 2×.

FIG. 3 is a table showing ON/OFF states of switches in relation to the gains of VGAs shown in FIG. 2.

FIG. 4 illustrates a structure of a digital camera according to a second embodiment of the present invention.

FIG. 5 illustrates a structure of a digital camera according to a third embodiment of the present invention.

FIG. 6 is a circuit diagram showing a VGA that can sample a voltage corresponding to an image, from an output of an image pickup device.

FIG. 7 illustrates an output voltage waveform of a CCD.

FIG. 8 illustrates a structure of a conventional AFE circuit.

FIG. 9 is a circuit diagram of a VGA configured as a switched-capacitor circuit.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

The present embodiments relate to a digital camera which performs a predetermined processing on an analog output signal of an image pickup device such as CCD and, thereafter, converts it to a digital signal so as to perform an image compression processing thereon.

### First Embodiment

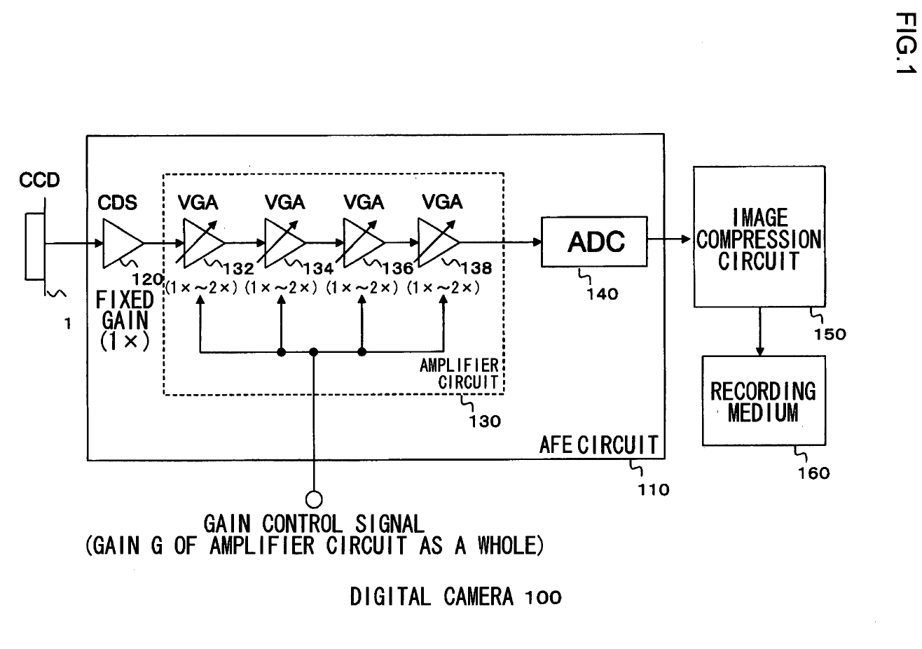

FIG. 1 illustrates a structure of a digital camera 100 according to a first embodiment of the present invention. This digital camera 100 comprises a CCD 1, an analog front end (AFE) circuit 110 which takes out a voltage corresponding to an image signal from a signal outputted from the CCD 1, amplifies the voltage and converts the voltage into a digital signal, and an image compression circuit 150 which performs an image compression processing on the digital signal outputted from the AFE circuit 110 and writes the compressed signal into a recording medium 160.

The AFE circuit 110 includes a correlated double sampling (CDS) circuit 120 which receives a signal inputted from the CCD 1 and takes out a voltage corresponding to an image signal from the signal, an amplifier circuit 130 which amplifies a signal outputted from the CDS circuit 120 at a variable gain, and an ADC 140 which converts the signal amplified by the amplifier circuit 130 into a digital signal.

The CDS circuit 120 is fixed at a gain of 1. The amplifier circuit 130 is so set that the maximum gain Gmax for the whole is 16 and the minimum gain is 1. The amplifier circuit 130 is formed by a VGA 132, a VGA 134, a VGA 136 and a VGA 138 connected in a cascaded manner, each of the four variable gain amplifiers having a gain controllable in a range of 1 to 2. And the amplifier circuit 130 as a whole is so set that the maximum gain is 16 and the minimum gain is 1.

The amplifier circuit 130 may be designed according to the guidelines as described below.

Firstly, the maximum gain Gmax of the amplifier circuit 130 is determined from the design specifications of the AFE circuit 110. Based on this, the maximum value X and the minimum value Y for the gain of a single stage of VGA used in the amplifier circuit 130 are set. The range of gain for the single stage of VGA may be set in accordance with the specifications required of the amplifier circuit 130, such as the current consumption and operation speed. Once the gain Gmax of the amplifier circuit 130 as a whole and the maximum value X for the gain of the single stage of VGA are decided, it is possible to determine the number of stages of VGA. That is, the number of stages n may be set as a natural number that satisfies Gmax≦Xⁿ. By designing the amplifier circuit 130 in this manner, the gain G of the amplifier circuit 130 as a whole can be adjusted within a range of Yⁿ≦G≦Xⁿ.

For example, in this first embodiment, the gain for a single stage of VGA is so set that the maximum value X is 2 and the minimum value Y is 1. Also, the maximum value Gmax for the gain of the amplifier circuit 130 as a whole is 16. Accordingly, by connecting four stages (n=4) of VGA, the gain of the amplifier circuit 130 may be set within the desired gain range of 1 to 16.

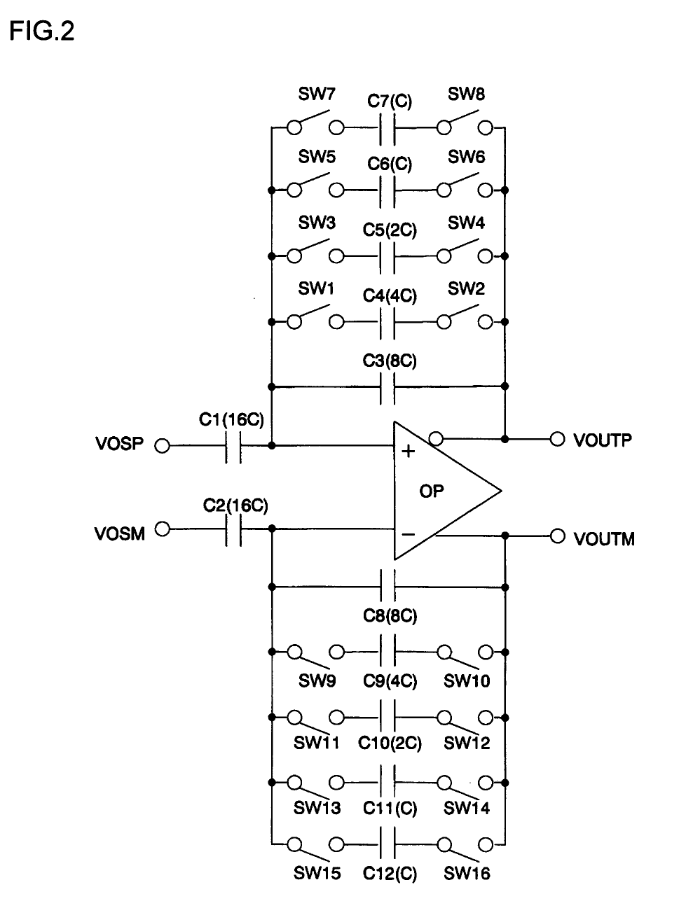

FIG. 2 illustrates an example of VGAs 132 to 138 configured as a switched-capacitor circuit. This circuit is formed by a differential amplifier OP, input capacitors C1 and C2, feedback capacitors C3 to C12 and switches SW1 to SW16. The capacitance of these capacitors are such that the input capacitors C1 and C2 are 16C, the feedback capacitors C3 and C8 are 8C, the feedback capacitors C4 and C9 are 4C, the feedback capacitors C5 and C10 are 2C, and the feedback capacitors C6, C7, C11 and C12 are C. Note that “C” as in “16C”, “8C”, “4C”, “2C” or “C” here is a predetermined basic capacitance value, or a unit capacitor.

The input capacitor C1 is coupled to the plus (+) input terminal of the differential amplifier OP, and the input capacitor C2 to the minus (−) input terminal thereof. The feedback capacitors C3 to C7 are disposed in parallel with one another between the (+) input terminal and the (+) output terminal of the differential amplifier OP, and the feedback capacitors C8 to C12 between the (−) input terminal and the (−) output terminal thereof.

Furthermore, the feedback capacitors C4 to C7 are coupled via switches SW1, SW3, SW5 and SW7, respectively, to the (+) input terminal of the differential amplifier OP and via switches SW2, SW4, SW6 and SW8, respectively, to the (+) output terminal thereof. Also, the feedback capacitors C9 to C12 are coupled via switches SW9, SW11, SW13 and SW15, respectively, to the (−) input terminal of the differential amplifier OP and via switches SW10, SW12, SW14 and SW16, respectively, to the (−) output terminal thereof. On the other hand, the feedback capacitors C3 and C8 are coupled directly to the input terminal and the output terminal of the differential amplifier OP.

The switches SW1 to SW16 are turned on and off according to the individual gains of VGAs 132 to 138 determined as will be discussed later. For example, when the gain of VGA is 2, all the switches are turned off. As a result, the feedback capacitance as a whole will be 8C for both + and − sides, and since the input capacitance is 16C for both + and − sides, the gain of VGA will be 2. When the gain of VGA is 1, all the switches are turned on. As a result, the feedback capacitance as a whole will be 16C for both + and − sides, and since the input capacitance is 16C for both + and − sides, the gain of VGA will be 1.

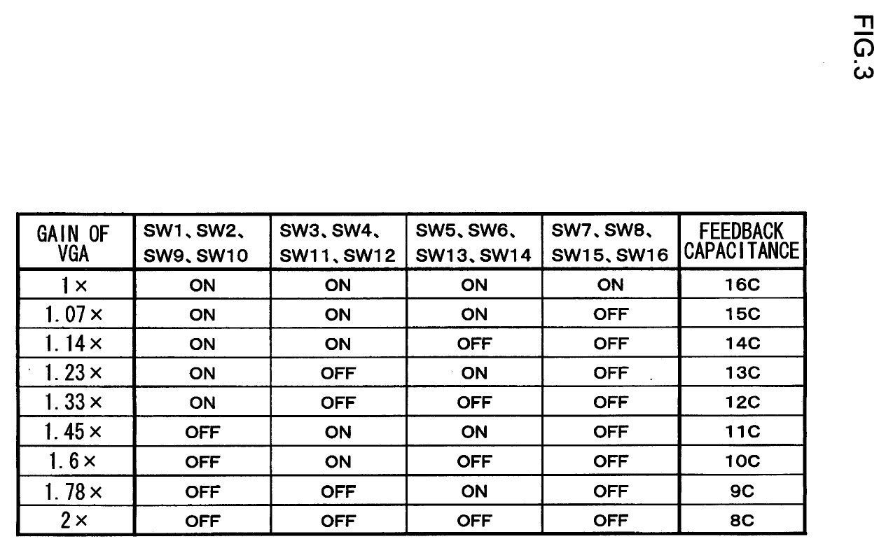

FIG. 3 is a table showing the ON/OFF states of switches SW1 to SW16 in relation to the gain of VGA and the feedback capacitances as a whole for the respective combinations of the switch states. As shown in the table of FIG. 3, the group of SW1, SW2, SW9 and SW10 is controlled to always assume the ON or OFF state simultaneously. Similarly, the group of SW3, SW4, SW11 and SW12, the group of SW5, SW6, SW13 and SW14, and the group of SW7, SW8, SW15 and SW16 are controlled to always assume their respective ON or OFF state simultaneously. Thus, as the switches are controlled according to the relationship in this table, desired gains are obtained for the respective VGAs.

A description will be given of the operation of a digital camera shown in FIG. 1 based on a structure as described above. As a CCD 1 takes in an image signal in the form of a drive signal (not shown), signals containing this image signal are successively outputted to an AFE circuit 110. Then the signals inputted to the AFE circuit 110 are processed by a CDS circuit 120 in such a manner that the image signal is taken out as an analog voltage signal, and the analog voltage signal is inputted to an amplifier circuit 130.

The amplifier circuit 130 controls the gains of VGA 132, VGA 134, VGA 136 and VGA 138 in a range of 1 to 2, respectively, according to a gain control signal generated by a control circuit (not shown) in such a manner that the gain of the circuit as a whole assumes a desired gain G. The gains of the respective VGAs are determined by a method as described below.

For example, the gains of the individual VGAs may be set to be the fourth root of G, or G^{1/4}. More generally, if n stages of VGA are to be used, then the gain may be set to be the nth root of G, or G^{1/n}. Alternatively, the gains of individual VGAs in correspondence to the value of G are stored beforehand in memory (not shown), and a control circuit (not shown) determines the respective gains of the VGAs according to the contents stored in the memory to achieve the desired gain G for the circuit as a whole. Or, in another arrangement, the gains of the respective VGAs may be so determined that they are preferentially larger from the first stage (or the final stage) of VGA. In still another arrangement, the gains of the respective VGAs may be so determined that the gains of the first and the final stage of VGA are preferentially larger than those of the intermediate stages of VGA.

An analog voltage signal is amplified by the amplifier circuit 130 according to the gain G set by any of method described above. The amplified signal is converted into a digital signal by an ADC 140. This digital signal is subjected to an image compression processing by an image compression circuit 150 according to the JPEG or JPEG2000 standard, for instance, before recorded in a recording medium 160.

The present embodiment is characterized by a feature that a plurality of VGAs which have each a small gain width of 1 to 2 are connected in a cascaded manner. As is clear from Equations (1) and (2), if VGAs are designed with the same process and form of the transistors and a fixed value of bias current, the mutual conductance of VGAs will be constant and therefore the operation speed will drop if the maximum gain is raised. Accordingly, when a plurality of VGAs with mutually different gains are connected in the cascaded manner, the operation speed as a whole is limited by the operation speed of a VGA having the largest gain. On the other hand, if the VGAs are designed so that the operation speed of the VGA having the largest gain is the same as that of the VGA having the smallest gain, it is indicated from Equations (1) and (2) that the bias current of the VGA with the largest gain is larger, by the square of the gain ratio each, than that of the VGA having the smallest gain. In other words, the power consumption of the amplifier circuit as a whole will increase. Hence, from the viewpoint of operation speed and power consumption, the amplifier circuit will be the most efficient when it has the following structure:
(a) A plurality of stages of VGA having as small a gain as practicably possible are connected.
(b) The gains of the plurality of VGAs are the same.

On the other hand, in controlling the gain of VGA, use of a multiplier of 2 (1 time, 2 times, 4 times, 8 times, . . . ) as the maximum value will make the control of individual VGAs easier. In this respect, VGAs whose gain is 1 to 4 may be used, but, as indicated by equations (1) and (2), VGAs, which are designed with the same speed, require exponentially more current for a larger maximum gain. Therefore, the cascade connection of two VGAs whose gain is 1 to 2 can reduce power consumption more effectively that the use of a single VGA whose gain is 1 to 4.

For reasons as described above, connection of a plurality of stages of VGA whose gain is 1 to 2 can not only raise the operation speed but also reduce power consumption.

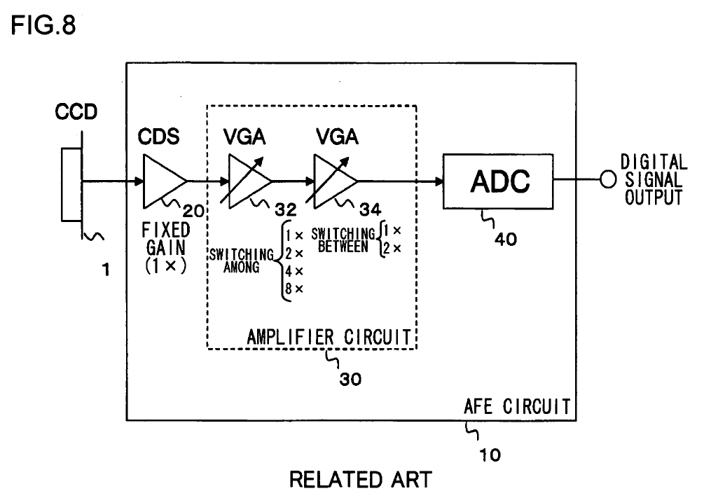

A concrete comparison is now made of an amplifier circuit 130 of an AFE circuit 110 according to the first embodiment of the present invention shown in FIG. 1 with an amplifier circuit 30 of a conventional-type AFE circuit 10 as shown in FIG. 8. For both the circuits, the range of variable gain is from a minimum of 1 to a maximum of 16. The amplifier circuit 30 of conventional type is formed by two stages of VGA, of which one has a gain of 1 to 8 and the other a gain of 1 to 2. On the other hand, the amplifier circuit 130 of the present embodiment, as described above, is formed by four stages of VGA, of which all have a gain of 1 to 2.

Now, suppose that the bias current of a VGA whose maximum gain is 2 is I₂. Then if a VGA whose maximum gain is 8 is operated at the same speed as a VGA whose maximum gain is 2, the bias current I₈ necessary for the VGA whose maximum gain is 8 is found as follows from the Equations (1) and (2) (on condition that the load capacitance is the same):

I₈=9×1₂ (3)

Hence, the total of bias current necessary for the conventional amplifier circuit 30 is 10×I₂. On the other hand, the total of bias current necessary for the amplifier circuit 130 according to the present embodiment is 4×I₂.

It is therefore apparent that an amplifier circuit formed by connecting more stages of VGA with smaller maximum gain can accomplish a faster operation with smaller bias current than an amplifier circuit formed by fewer stages of VGA with larger maximum gain. This is because setting of large gains for VGAs results in an exponential increase in bias current necessary for operating such VGAs at high speed.

Thus, by implementing the above structure, the following advantageous effects are achieved:
(1) Structuring an amplifier circuit by connecting multiple stages of amplifier whose gain is practically 1 to 2 can accomplish a faster operation with smaller bias current, which creates an amplifier circuit featuring both reduced power consumption and higher-speed operation.
(2) Moreover, reduced power consumption and higher-speed operation can also be achieved simultaneously in an AFE circuit using an amplifier circuit of this structure or in a digital camera using this AFE circuit.

### Second Embodiment

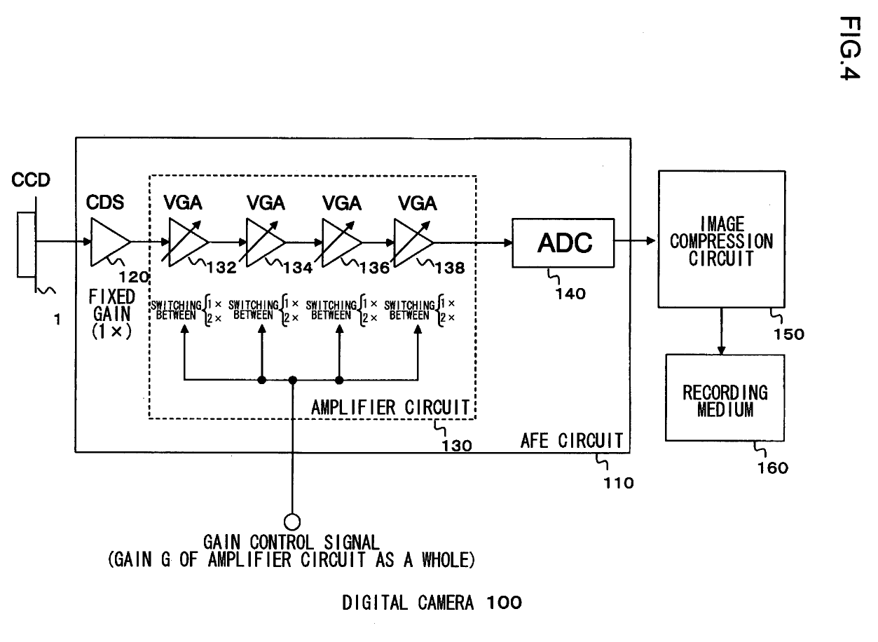

FIG. 4 illustrates a structure of a digital camera 100 according to a second embodiment of the present invention. This structure is similar to the digital camera 100 shown in FIG. 1 and therefore the new features only characteristic of this second embodiment will be described here and the description of anything else will be omitted.

In this second embodiment, the four variable gain amplifiers VGA 132, VGA 134, VGA 136 and VGA 138 forming an amplifier circuit 130 are those configured as a switched-capacitor circuit for which the gain can be set to 1 or 2.

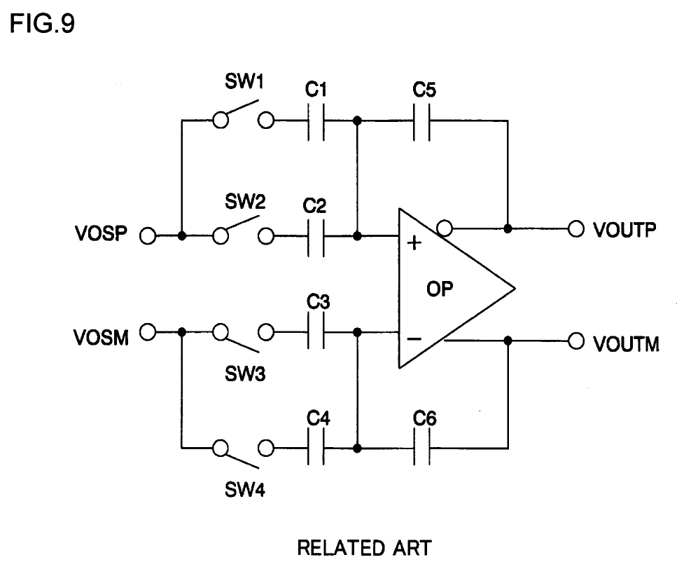

A VGA whose gain can be selectively set to 1 or 2 may be realized easily by structuring a switched-capacitor circuit as shown in FIG. 9. That is, using a design of capacitors C1 to C6 all having the same capacitance, a gain of 1 is obtained when SW1 and SW4 only are turned on, and a gain of 2 is obtained when SW1 to SW4 are all turned on. Thus, a VGA configured as a switched-capacitor circuit for which the gain can be selectively set to 1 or 2 may be advantageous in that the circuit thereof is easy to structure and the input capacitance (C1 to C4) can be made smaller.

The operation of a digital camera having a structure as described above is nearly the same as that of a digital camera shown in FIG. 1, but the gain for each of VGA 132, VGA 134, VGA 136 and VGA 138 included in the amplifier circuit 130 is determined in a slightly different manner. When required to control the gain of the circuit as a whole to assume a desired gain G, the amplifier circuit 130 controls the gains of VGA 132, VGA 134, VGA 136 and VGA 138 to be 1 or 2, respectively, according to a gain control signal generated by a control circuit (not shown).

For example, the gains of individual VGAs in correspondence to the value of G are stored beforehand in memory (not shown), and a control circuit (not shown) determines the respective gains of the VGAs to be 1 or 2 to achieve the desired gain G for the circuit as a whole. Or, according to the desired G value, the gain may be selectively set to 1 or 2 in sequence from the first stage (or the final stage) of VGA. Or, in another arrangement, according to the desired G value, the gains for the first stage VGA 132 and the final stage VGA 138 may be first selectively set to 1 or 2 and then the gains for the intermediate stages VGA 134 and VGA 136 may be selectively set to 1 or 2.

By implementing the structure described as above, the following advantageous effects are enjoyed.
(1) A. VGA configured as a switched-capacitor circuit allows the control of the gain by switching it to 1 or 2, so that the gain control for the amplifier circuit as a whole can be made simpler and the control circuit may be structured at lower cost.
(2) When the stages of a VGA configured as a switched-capacitor circuit are connected in a cascaded manner, the input capacitance of each VGA stage becomes the load capacitance of a preceding-stage VGA, so that the input capacitance serves as one of the limiting factors for the operation speed. However, by the use of two kinds of settable gain, namely, 1 and 2, the input capacitance for each VGA stage can be made smaller. Thus, such an arrangement can realize high speed and low power consumption for a smaller area of the circuit.

### Third Embodiment

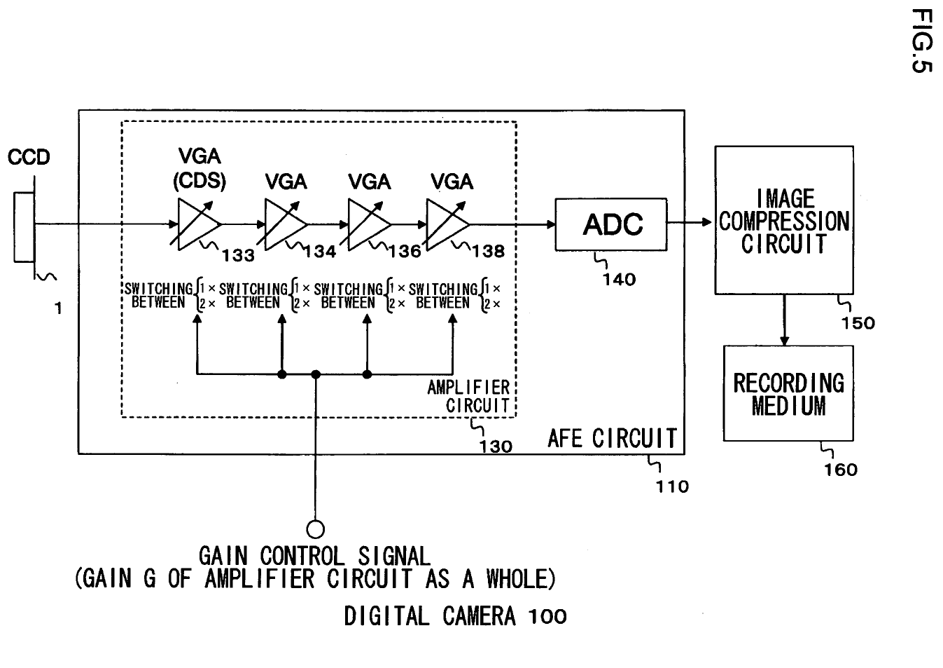

FIG. 5 illustrates a structure of a digital camera 100 according to a third embodiment of the present invention. This structure is similar to the digital camera 100 shown in FIG. 1 and therefore the new features only characteristic of this third embodiment will be described here and the description of anything else will be omitted.

The third embodiment differs from the second embodiment in the points where the CDS circuit 120 shown in FIG. 1, which receives a signal outputted from the CCD 1 and takes out a voltage corresponding to an image signal from said signal, is eliminated in this third embodiment and a VGA 133 to which a function corresponding to a role of CDS circuit is added is used in place of the VGA 132 located at the first stage of the amplifier circuit 130.

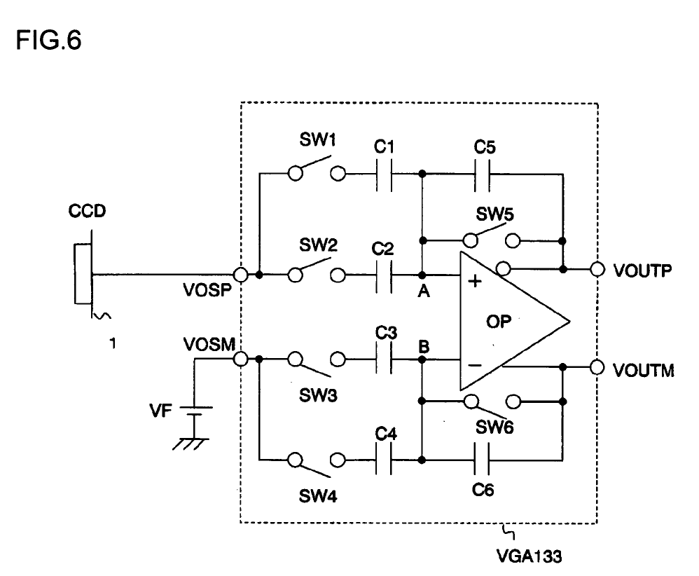

The VGA 133 can be easily realized by the configuration of a switched-capacitor circuit shown in FIG. 6. And the magnitudes of capacitors C1 to C6 are so configured as to be the same capacitance value of C each. The voltage outputted from a CCD 1 is inputted to an input VOSP of VGA 133 and a predetermined voltage VF is inputted to an input VOSM.

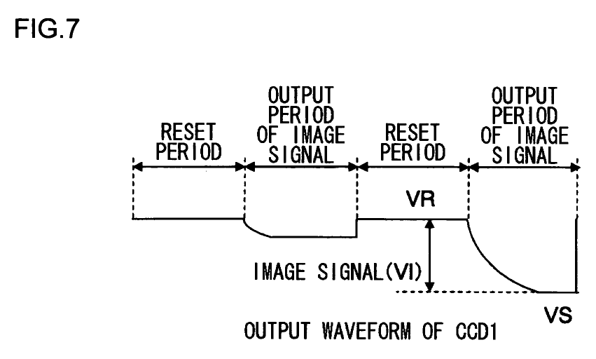

A voltage waveform outputted from the CCD 1 is divided into reset periods and output periods of image signal as shown FIG. 7. A difference between a voltage VR outputted during a reset period and a voltage VS outputted during an output period of image signal is a voltage VI corresponding to the image signal.

An operation of the VGA 133 will be described hereinbelow. During a period in which the voltage being outputted from the CCD 1 is VR, namely, during a rest period, switches SW5 and SW6 are turned on. Then the input terminal and the output terminal at + side of differential amplifier OP are short-circuited and those at − side thereof are short-circuited. At the same time, the input capacitance is determined by controlling the ON/OFF of switches SW1 to SW4. If the switches SW1 and SW4 only are turned on, the capacitor C1 becomes the capacitance of + side and the capacitor C4 becomes the capacitance of − side, and the capacitance values thereof are each C. If the switches SW1 to SW4 are all turned on, the capacitors C1 and C2 become the capacitance of + side and the capacitors C3 and C4 become the capacitance of − side, and the capacitance values thereof are each 2C. In this state, the output terminal and the output terminal of the differential amplifier OP are short-circuited on both the + and − sides, so that the voltage at all terminals is the same. Now, let this voltage be denoted by VAZ.

Then, an electric charge QIR₊ stored on the input capacitance at the + side and an electric charge QIR₋ stored on the input capacitance at the − side are expressed by the following Equation (4) and Equation (5), respectively.
QIR₊=CI(VR−VAZ) (4)
QIR₋=CI(VF−VAZ) (5)
where CI is an input capacitance value.

In this state, the capacitor C5 which is the feedback capacitance at the + side and the capacitor C6 which is the feedback capacitance at the − side are short-circuited by the switches SW5 and SW6. Therefore; the capacitor C5 and C6 are not charged. In other words, the electric charges of the capacitors C5 and C6 are zero.

Then the switches SW5 and SW6 are turned off immediately before the reset period ends. Thereby, the two input terminals of the differential amplifier OP, namely, the (+) input terminal and the (−) input terminal, are virtually grounded so that a connected node A and a connected node B have each the same potential VL. And when the output from the CCD 1 enters an output period of image signal and the voltage being inputted to the input VOSP of the VGA 133 changes from VR to VS, an electric charge QIS₊ stored on the input capacitance at the + side and an electric charge QIS₋ stored on the input capacitance at the − side are expressed by the following Equation (6) and Equation (7), respectively.
QIS₊=CI(VS−VL) (6)
QIS₋=CI(VF−VL) (7)

An electric charge QFS₊ stored on the feedback capacitance at the + side and the electric charge QFS₋ stored on the feedback capacitance at the − side are expressed by the following Equation (8) and Equation (9), respectively.
QFS₊=CF(VOUTP−VL) (8)
QFS₋=CF(VOUTM−VL) (9)
where CF is a feedback capacitance value.

According to the principle of conservation of charge, the electric charge stored on the input capacitance during a reset period equals the sum of the electric charge stored on the input capacitance and the electric charge stored on the feedback capacitance during an output period of image signal. That is, the following Equation (10) and Equation (11) hold.
CI(VR−VAZ)=CI(VS−VL)+CF(VOUTP−VL) (10)
CI(VF−VAZ)=CI(VF−VL)+CF(VOUTM−VL) (11)

When the left-hand side of Equation (11) is subtracted from the left-hand side of Equation (10) and at the same time the right-hand side of Equation (11) is subtracted from the right-hand side of Equation (10), the following Equation (12) is derived.
CI(VR−VF)=CI(VS−VF)+CF(VOUTP−VOUTM) (12)

Hence, transforming this Equation (12) arrives finally at the following Equation (13).
VOUTP−VOUTM=(CI/CF)·(VR−VS)=(CI/CF)·VI (13)

As can be seen from Equation (13), when the output voltage of CCD 1 changes VR to VS during an output period of image signal, the voltage VI corresponding to the image signal is amplified at the ratio of the input capacitance CI to the feedback capacitance CF and is then outputted as the difference between the output VOUTP and the output VOUTM. That is, by implementing the VGA 133, the voltage corresponding to the image signal is retrieved from the CCD 1 and the thus retrieved voltage can be amplified. If the switches SW1 and SW4 only are turned on, the input capacitance is C and the feedback capacitance is also C, so that the gain CI/CF of VGA 133 is 1. If the switches SW1 to SW4 are all turned on, the input capacitance is 2C and the feedback capacitance is C, so that this time the gain CI/CF of VGA 133 is 2. Accordingly, the gain of VGA 133 can be selectively set to either 1 or 2 by switching the switches SW1 to SW4.

The timing of on and off of the switches SW5 and SW6 is determined by a drive signal outputted from a drive circuit (not shown) of the CCD 1.

In order for the gain of the amplifier circuit 130 as a whole to acquire a desired value G, the determination of the gains respectively at the VGA 133, VGA 134, VGA 136 and VGA 138 can be performed by using a method similar to that explained in the second embodiment of the present invention. That is, when it is requested by a gain control signal generated by a control circuit (not shown) that the gain of the entire amplifier circuit be the intended gain G, the respective gains at VGA 133, VGA 134, VGA 136 and VGA 138 are so controlled as to be 1 or 2 using a similar method described in the second embodiment of the present invention.

As described above, the total number of VGAs including a VGA playing the role of a CDS circuit is four in this third embodiment. In contrast thereto, the total number of VGAs and CDS circuit is five in the second embodiment as shown in FIG. 2. On the other hand, the gain of the entire amplifier circuit 130 is such that the maximum gain is 16 and the minimum gain is 1 in both the second and the third embodiment.

If a circuit is configured such that a capacitor is charged via a resistance component, thermal noise is caused at a connection node between a resistor and a capacitor. For instance, if the CDS circuit and/or amplifiers are implemented because of a switched-capacitor circuit configuration, the switches become resistance components. As a result thereof, thermal noise is generated. Thus, if the CDS circuit and amplifiers are connected in a multiple stage, the switched-capacitor circuit suffers from the accuracy deterioration due to thermal noise.

On the other hand, by employing the structure according to the third embodiment, the total number of CDS circuit and VGAs included in a signal processing circuit can be reduced, so that the accuracy deterioration caused by thermal noise can be suppressed.

Although in the third embodiment an example is shown in which the gain can be switched to 1 or 2, the VGA may be such that the gain thereof can be selected in a range of 1 to 2 in a multiple-stage or continuous manner as described in the first embodiment of the present invention.

The present invention has been described based on the embodiments which are only exemplary. It is therefore understood by those skilled in the art that there exist other various modifications to the combination of each component and process described above and that such modifications are also encompassed by the scope of the present invention.

For instance, although the VGA is configured by, for example, a switched-capacitor circuit in the present embodiments, the structure of VGA is not limited thereto. And if there is provided an amplifier whose gain is variable, it will be within the scope of the present invention.

In the present embodiments, four stages of VGAs each of which has the gain of 1 to 2 are cascade-connected so as to constitute an amplifier circuit of 1× to 16×. If an amplifier circuit more than 16×(e.g., 32× or 64×) is to be implemented, the VGA which has the gain of 1 to 2 may be cascade-connected in five or more of stages (five stages in the case of 32× and six stages in the case of 64×). In any case of a plurality of stages of VGAs, it is preferred that the number of stages n be set so that Xⁿ≧Gmax holds where Gmax is the maximum gain and X is the maximum value for the gain of a single stage of VGA. In order to achieve both the reduced power consumption and the high speed of operation, it is preferable that a VGA having small gain of 1 to 2 is connected in a plurality of stages instead of reducing the number of connection stages by increasing the gain range.

In the present embodiments, an example is shown where the output of the amplifier circuit 130 is connected to the ADC 140. The input capacitance to an ADC is generally large and turns out to be a large load in a VGA located at the last stage of the amplifier circuit 130. Hence, even if the gain of VGA is made smaller, there may be a case where the operation speed is limited thereby. In order to cope with this, a circuit of small input capacitance and high drive capacity may be inserted between the amplifier circuit 130 and the ADC 140. The circuit of small input capacitance and high drive capacity may be a sample-and-hold circuit, a voltage-follower or a source-follower.

In the present embodiments, the description has been given of a digital camera, but the present embodiments are not limited thereto. Any amplifier circuit in which a plurality of amplifiers whose gain is each variable in the range of 1 to 2 are connected in a multiple stage and the gain of an amplifier circuit as a whole is determined by controlling the gains of such individual amplifiers and any apparatus which contains such the amplifier circuit are within the scope of the present invention.

While the preferred embodiments of the present invention have been described using specific terms, such description is for illustrative purposes only, and it is to be understood that changes and variations may be further made without departing from the scope of the present invention which is defined by the appended claims.

What is claimed is:

1. An amplifier circuit having a plurality of stages of amplifiers, the circuit characterized in that each of the plurality of stages of amplifiers is configured in a manner such that gain is variably set to at least two kinds in a range between 1 and 2 and gain of said amplifier circuit as a whole is determined by controlling gain of each amplifier.

2. An amplifier circuit according to claim 1, wherein the gain of each amplifier is set in such a manner as to be selectable as 1 or 2.

3. An amplifier circuit, having a plurality of stages of amplifiers, in which a maximum value of gain as a whole is given by Gmax, the circuit characterized in that gain of each of the plurality of stages of amplifiers is variably set to at least two values in a range between 1 and X (X≦2) and the amplifiers are connected in n stages in a cascaded manner where n is a natural number such that Gmax≦Xⁿ.

4. An amplifier circuit according to claim 3, wherein X is 2 and the gain of each amplifier is variably set by two values which are 1 and 2.

5. An amplifier circuit according to claim 1, wherein the amplifier is variable-gain amplifier configured by a switched-capacitor circuit.

6. An amplifier circuit according to claim 3, wherein the amplifier is variable-gain amplifier configured by a switched-capacitor circuit.

7. A signal processing circuit, comprising:
a sampling circuit which takes out, from a signal outputted by an image pickup device, a voltage corresponding to an image signal;
an amplifier circuit according to claim 1, which amplifies the voltage taken out by said sampling circuit; and
an analog-to-digital conversion circuit which converts the voltage amplified by said amplifier circuit to a digital signal.

8. A signal processing circuit, comprising:
a sampling circuit which takes out, from a signal inputted by an image pickup device, a voltage corresponding to an image signal;
an amplifier circuit according to claim 3, which amplifies the voltage taken out by said sampling circuit wherein said amplifier circuit; and
an analog-to-digital conversion circuit which converts the voltage amplified by said amplifier circuit to a digital signal.

9. A signal processing circuit, comprising:
an amplifier circuit according to claim 1; and
an analog-to-digital conversion circuit which converts the voltage amplified by said amplifier circuit to a digital signal,
wherein an amplifier of first stage in said amplifier circuit samples a voltage corresponding to an image signal, from a signal outputted by an image pickup device.

10. A signal processing circuit, comprising:
an amplifier circuit according to claim 3; and
an analog-to-digital conversion circuit which converts the voltage amplified by said amplifier circuit to a digital signal,
wherein an amplifier of first stage in said amplifier circuit samples a voltage corresponding to an image signal, from a signal outputted by an image pickup device.

11. A digital camera, comprising:
an image pickup device;
a signal processing circuit according to claim 9 which takes out, from a signal outputted by said image pickup device, a voltage corresponding to an image signal, amplifies the voltage and converts the amplified voltage to a digital signal; and
an image compression circuit which performs image compression processing on the digital signal.

12. A digital camera, comprising:
an image pickup device;
a signal processing circuit according to claim 10 which takes out, from a signal outputted by said image pickup device, a voltage corresponding to an image signal, amplifies the voltage and converts the amplified voltage to a digital signal; and
an image compression circuit which performs image compression processing on the digital signal.
